(19) United States
(12) Patent Application Publication
(10) Pub. No.: US 2024/0165599 A1
(43) Pub. Date: May 23, 2024

(54) METHOD AND APPARATUS FOR THE PREPARATION OF A SUBSTRATE FOR AN EXHAUST GAS AFTERTREATMENT DEVICE

(71) Applicant: UMICORE AG & CO. KG, Hanau-Wolfgang (DE)

(72) Inventors: Karoline KOZUBSKI, Rheinfelden (DE); Karlheinz RUCKDAESCHEL, Schallbach (DE); Andrea DE TONI, Hanau (DE); Christian DUFNER, Rheinfelden (DE); Patrick MONSKE, Schopfheim (DE); Melanie WASSMER, Rheinfelden (DE)

(73) Assignee: UMICORE AG & CO. KG, Hanau-Wolfgang (DE)

(21) Appl. No.: 18/509,637

(22) Filed: Nov. 15, 2023

(30) Foreign Application Priority Data
Nov. 17, 2022 (DE) 102022130469.8

(51) Int. Cl. B01J 37/02; B01J 35/56; B05C 7/00

(52) U.S. Cl. CPC B01J 37/0215; B01J 35/56; B05C 7/00

(57) ABSTRACT

The invention relates to a method for producing a substrate (1) for an exhaust gas aftertreatment device, having the following steps:
applying (S1) a coating material (12) on an elastic base (11);
dipping or pressing (S2) a surface of the substrate (1), in which inlet openings of through-channels (2) are arranged, through the substrate (1) into the coating material (12);
lifting off the coated catalyst element (1); and
aftertreating, and in particular drying or calcining (S3), the coating material (12) on the coated substrate (1).

### TECHNICAL FIELD

The invention relates to substrates for exhaust gas aftertreatment devices as catalyst elements or filter elements for internal combustion engines, and in particular measures for preventing the occurrence of clogging/blocking phenomena, also known as face plugging, at a fluid flow inlet of the catalyst element.

### TECHNICAL BACKGROUND

Exhaust gas aftertreatment devices—in particular, in the form of catalysts, i.e., catalytically-coated wall-flow filters—or filters are generally used for the purification of combustion exhaust gases—for example, from internal combustion engines. These enable the chemical conversion of undesired components of the combustion exhaust gas, such as carbon monoxide, nitrogen oxides, unburnt hydrocarbons, soot, and the like, or a filtering of combustion exhaust gas. As a rule, exhaust gas aftertreatment devices of this kind have one or more substrate bodies. A substrate body generally comprises several through-channels. The through-channels extend completely through the substrate body or, in the case of a wall flow filter, mostly through the substrate body, so that a filter is formed by the porous substrate material between adjacent filter channels. The inner walls of the through-channels may be coated with a catalyst material to form a catalytic surface on which corresponding reactions and/or absorptions can take place to eliminate the undesired exhaust gas components.

The through-channels run generally parallel in the substrate and are separated from one another by walls of the substrate material—in particular, a ceramic material. The through-channels generally have inlet openings which are arranged on a face of the substrate. This leads to the fact that the face on which the inlet openings of the through-channels are arranged has a plurality of webs on which components of the exhaust gas, such as particles, aerosols, droplets, and the like, can be deposited during the operation of the exhaust gas aftertreatment element and can form a down of contamination. This process is known as clogging, blocking, or sooting, and is generally referred to as face plugging. Face plugging occurs in particular in operating states in which the exhaust gas contains many soot particles or aerosols.

The exhaust gas back-pressure in the exhaust gas aftertreatment device is increased by face plugging, which can impair the efficiency of the internal combustion engine. If the face plug is not removed, a system failure can also occur.

One option for preventing face plugging is to provide the face of a substrate with a precious-metal-containing coating, which has enhanced catalytic properties. Such a measure is known, for example, from the document EP 2171232 B1. From this, a device for the aftertreatment of engine exhaust gases is known which has a substrate that has a cellular structure defining fluid passages that are designed to enable fluid flow through the substrate, wherein the substrate has an inlet end surface that is positioned at one end of the substrate, wherein the substrate is coated with a chemical coating. The chemical coating on the inlet end surface has an increased load relative to any other chemical coating on the substrate in order to prevent and/or eliminate a surface entry blockage on the substrate, wherein the inlet end surface comprises a three-dimensional topographical configuration so that the substrate is non-planar at the inlet end, and the chemical coating is arranged on the three-dimensional topographical design.

Due to the production process of such substrates for exhaust gas aftertreatment devices, apart from the inlet openings of the through-channels, the face on which the inlet openings of the through-channels are arranged is not flat, but can have an irregular, concave, or convex design. This makes it difficult to apply a face coating, which is supposed to be provided—in particular, uniformly—on all web-like structures between the through-channels.

In this regard, document EP 3195348 B1 provides a system for depositing a surface coating on a monolithic catalytic substrate. The system comprises a coating liquid applicator which is arranged between an inflow and discharge system, wherein the coating liquid applicator has an inner core and an outer nub with a height, a coating liquid trough positioned below the coating liquid applicator, to receive the full length of the coating liquid applicator within the coating liquid trough and to retain a coating liquid. The coating liquid trough is positioned vertically such that the nub of the coating liquid applicator is at least partially immersed in the coating liquid. With a motor, the coating liquid applicator is driven at a certain predetermined rotational speed during operation, wherein operation is controlled depending upon a sensor signal from a light sensor. During operation, a substrate coating liquid is applied to the coating liquid applicator, a monolithic catalytic substrate is moved through the coating liquid applicator at the predetermined speed so that an amount of the coating liquid is transferred from the coating liquid applicator to a surface of the monolithic catalytic substrate, wherein, depending upon a detection of whether a light beam is blocked by the coating liquid applicator, the height of the coating liquid applicator is set at an adjusted height.

Furthermore, the document EP 3400108 B1 discloses a method for coating a terminal surface of a substrate with a liquid, which comprises a catalyst component, wherein a substrate is conveyed to a coating roller, and the liquid is applied to a terminal surface of the substrate by bringing the terminal surface into contact with the coating roller, which is loaded with the liquid. Conveying the substrate to the coating roller comprises bringing the terminal surface of the substrate into contact with a rotating surface of the coating roller. In this case, the terminal surface is brought into contact with the rotating surface of the coating roller.

The above prior art has the disadvantage that it does not allow a reproducible, uniform coating in the case of non-planar faces of the substrate. The penetration depth of the coating material into the through-channels also cannot be adjusted by the known manufacturing processes.

It is an object of the present invention to provide a method for coating a face surface of a substrate, which has inlet openings of through-channels, with a coating material that reduces face-plugging, which enables uniform coating even in the case of non-planar faces of the substrate, and enables a reproducible layer thickness and penetration depth into the through-channels.

### Disclosure of the Invention

This object is achieved by the method for producing a substrate for an exhaust gas aftertreatment device according to claim 1 and a corresponding device and a substrate according to the independent claims.

Further embodiments are specified in the dependent claims.

According to a first aspect, a method for producing a substrate for an exhaust gas aftertreatment device is provided, having the following steps:
applying a coating material on an elastic base;
dipping or pressing into the coating material a surface of the substrate at which inlet openings of through-channels through the substrate are arranged;
lifting off the coated catalyst element; and
aftertreating, and in particular drying or calcining, the coating material on the coated substrate.

In order to prevent face plugging in an exhaust gas aftertreatment device which has one or more substrates, it is common to provide a coating of the face of the substrate with a coating material in a separate production step. The face corresponds to one side of the substrate in which openings, and in particular the inlet openings, of the through-channels end in the substrate. The coating is generally carried out with a precious-metal-containing material.

Suitable substrates are the embodiments known to a person skilled in the art in the automotive exhaust field. The through-channels can penetrate the substrate completely—so-called flow-through substrates—or, in the case of a wall-flow filter, can extend into the catalyst element to such an extent that, between parallel adjacent through-channels, the porous substrate material constitutes a filter.

Flow-through substrates are conventional catalyst elements in the prior art, which can consist of metal or fiberglass-reinforced paper (corrugated carrier, e.g., WO17153239A1, WO16057285A1, WO15121910A1, and the literature cited therein), or ceramic materials. Refractory ceramics, such as cordierite, silicon carbide, or aluminum titanate, etc., are preferably used. The number of channels per area is characterized by the cell density, which typically ranges between 300 and 900 cells per square inch (cpsi). The wall thickness of the channel walls in ceramics is between 0.5-0.05 mm.

All ceramic materials customary in the prior art can be used as wall-flow filters. Porous wall-flow filter substrates made of cordierite, silicon carbide, or aluminum titanate are preferably used. These wall-flow filter substrates have inflow and outflow channels, wherein the respective downstream ends of the inflow channels and the upstream ends of the outflow channels are alternately closed off with gas-tight “plugs.” The exhaust gas that is to be purified and that flows through the filter substrate is thereby forced to pass through the porous wall between the inflow channel and outflow channel, which delivers an excellent particulate filtering effect. The filtration property can be designed for particulates by means of the porosity, pore/radii distribution, and thickness of the wall. The porosity of the wall-flow filters is usually more than 40%, generally 40% to 75%, and particularly 45% to 70% [as measured in accordance with DIN 66133, latest version on the filing date]. The average pore size (diameter) is at least 3 μm—for example, 3 μm to 34 μm, preferably more than 5 μm, and in particular 5 μm to 28 μm, or 7 μm to 22 μm [measured according to DIN 66134, latest version on the date of application].

The surfaces in the through-channels of the substrate can be coated with a catalyst material. The process step of coating the through-channels is optional and can take place before, during, or after the process step of face coating with the coating material. Between these process steps, drying, reduction, and calcination steps can take place. The precious-metal-containing coating material can be identical to the catalyst material, can be different therefrom, or can have a modified concentration of catalytically-active components. The coating material can be produced, for example, on the basis of precious-metal-containing solutions or suspensions with an adsorbent or non-adsorbent property; in particular, Rh-, Pt-, and Pd-containing precious metal solutions or suspensions should be mentioned here. Such coating materials then have catalysts for the oxidation of hydrocarbons into H₂O and CO₂.

The oxidation function is essentially provided by the metals Rh, Pt, and/or Pd, and preferably Pt and/or Pd or Rh or Rh and Pd, which, in an alternative embodiment, are supported on active aluminum with a high surface area. Active aluminum contains up to 10 wt %, relative to the aluminum oxide, lanthanum and/or SiO₂ as admixture. In an alternative but preferred embodiment, the oxidative function is provided by Rh, and/or Pd, and/or Pt, which are supported on a mixture of high-surface-area aluminum oxide and common oxygen storage materials such as cerium oxides, cerium-zirconium mixed oxides, or La, Y, Pr, Nd-doped cerium or cerium-zirconium mixed oxides.

High-surface-area, temperature-stable oxides are considered by those skilled in the art carrier oxides for catalytically-active metals. As a rule, these are aluminum oxides, silicon oxides, zirconium oxides, or titanium oxides, or mixtures thereof. Active aluminum oxide in particular is known to a person skilled in the art in this connection. It particularly describes γ-aluminum oxide with a surface of 100 to 200 m²/g. Active aluminum oxide is frequently described in the literature and is commercially available. It generally contains silicon oxide or lanthanum oxide as a stabilizer in an amount of up to 10 wt % relative to the aluminum oxide.

However, the precious metals can also be present as a solution. In this connection, precious metal solutions are those which have the precious metals dissolved in a solvent—preferably water. A person skilled in the art knows which solutions can be used in this case. Precious metal compounds for producing the solution are in particular the following:

The palladium compound is selected from tetraamine palladium(II) chloride, palladium hydroxide, palladium chloride, palladium sulfate, palladium nitrate, diammine dinitritopalladium(II) chloride, diammine dinitritopalladium(II) sulfate, palladium glycinate, tetraamine palladium(II) sulfate, bis(ethylenediamino)palladium(II) carbonate, bis(ethylenediamino)palladium(II) sulfate, bis(acetylacetonato)palladium(II), diamine dichloropalladium(II), palladium oxide hydrate, tetraamine palladium(II) hydrogen carbonate, bis(ethylenediamino)palladium(II) chloride, and palladium acetate.

The rhodium compounds are selected from rhodium(III) chloride, rhodium(III) iodide, rhodium(III) oxide hydrate, rhodium(III) nitrate, and rhodium(III) sulfate.

The platinum compound is selected from platinum(II) chloride, tetrachloroplatinum(II) acid H₂(PtCl₄), dinitrosulfatoplatinum(II) acid and salts thereof, diamminodinitritoplatinum(II), tetraammineplatinum(II) salts, platinum(II) nitrate, hexachloroplatinum(IV) acid H₂(PtCl₆), hexahydroxoplatinum(IV) acid, and salts thereof.

To adjust the viscosity of the coating materials, appropriate auxiliaries such as thickeners, surface-active substances, acids or bases, or shear-thinning substances can be added. A person skilled in the art knows how to proceed here (e.g., EP3131660B1).

For the construction of catalyst elements, the substrates can be coated with different catalyst materials and can thus form various catalyst technologies. Several substrates having one or various technologies can be installed in an exhaust gas system. The face coating can be used on any component in which the occurrence of face plugging is expected. The application and the mode of operation of the face coating is independent of the component function or the coated catalyst technology. The catalyst technologies can, for example, but not exclusively, be DOC catalysts, NSC catalysts, DPF catalysts, 3-way catalysts (TWC), SCR catalysts, ASC catalysts, or combinations of the technologies.

Diverse catalyst materials are known from the prior art, e.g., zeolites with Cu, Fe, V,W,Ce, Sb, Nb, Zr, Mo, Al, Pd can be used for SCR catalysts, as for example known from WO 2008/132452 A2, WO 2019/096785 A1, WO 2019/096786 A1, WO 2022/058404 A1, WO 2020/043662 A1, WO 2015/075083 A1, WO 2019/072527 A1, WO 2019/072527 A1, WO 2019/219629 A1, WO 2020/039074 A1, WO 2018/189177 A1, WO 2017/134001 A1, WO 2017/134005 A1, WO 2017/134006 A1, WO 2017/134007 A1, WO 2013/159825 A1, WO 2017/178576 A1, WO 2018/054928 A1, WO 2018/029330 A1, and WO 2022/128523 A1. Catalyst materials used for TWC catalysts are known, for example, from WO2022223688A1, WO2021151876A1, WO2021140326A1, WO2008000449A2, WO2008113445A1, and WO2008113457A1. A person skilled in the art is aware of which he would use for the present purpose (see also, for example, WO2019121994A1, WO2019121995A1, WO9535152A1, WO2008000449A2, EP0885650A2, EP1046423A2, EP1726359A1, EP1541220A1, EP1900416B1, EP3045226A1, WO2009012348A1, and EP1974809B1).

Three-way catalysts consist essentially of the components, precious metal, high-surface-area carrier oxide, and oxygen-storing material. The oxygen storage materials are in particular those in which cerium/zirconium/rare earth metal mixed oxides occur. Lanthanum oxide, yttrium oxide, praseodymium oxide, neodymium oxide, samarium oxide, and mixtures of one or more of these metal oxides may, for example, be considered the rare-earth metal oxide. Lanthanum oxide, yttrium oxide, neodymium oxide, and mixtures of one or more of these metal oxides are preferred. Particularly preferred are lanthanum oxide and yttrium oxide, and a mixture of lanthanum oxide and yttrium oxide is quite particularly preferred in this connection.

High-surface-area, temperature-stable oxides are considered by those skilled in the art carrier oxides for catalytically-active metals. As a rule, these are aluminum oxides, silicon oxides, zirconium oxides, or titanium oxides, or mixtures thereof. Active aluminum oxide in particular is known to a person skilled in the art in this connection. It particularly describes γ-aluminum oxide with a surface of 100 to 200 m²/g. Active aluminum oxide is frequently described in the literature and is commercially available. It generally contains silicon oxide or lanthanum oxide as a stabilizer in an amount of up to 10 wt % relative to the aluminum oxide.

Three-way catalysts for the most part contain platinum group metals such as Pt, Pd, and Rh as catalytically-active components, with Pd and Rh being particularly preferred. The catalytically-active metals are often deposited in a highly disperse manner on the high surface area oxides and the oxygen storage materials. It is particularly preferred for the precious metals to be pre-fixed on the oxygen storage material before it is mixed with the other components into the coating mixture. With the TWC's, a zoned or layered embodiment is now the normal case. In a preferred embodiment, at least the TWC1 has a 2-layer structure with two different three-way coatings—preferably as described in EP3247493A1.

The face coating with the coating material is to be carried out in such a way that only the face surfaces of the webs between the through-channels are coated, and the inner surfaces of the through-channels are wetted with the coating material only up to a maximum depth of 0 to 20 mm, preferably between 0 and 5 mm, and particularly preferably between 0 and 2 mm.

As a result of production, the faces of a substrate that is to be coated at its faces are not flat, but, rather, can have a convex or concave structure, or a structure which is irregularly shaped in some other way. This 3-D structure of the faces can also vary within a batch of substrates.

For uniform coating with the coating material, the above method provides for pressing the face of the catalyst element into a flatly-applied coating material. The coating material is provided in liquid form as a dispersion, suspension, solution, gel, or the like, which is provided with catalytically-active materials.

It can be provided that the liquid coating material be applied flatly, and in particular with a constant layer thickness, to the elastic base, which in particular is oriented horizontally.

Subsequently, the face to be coated is pressed into the elastic base. The base yields when the face of the substrate is pressed in, so that the coating material located thereon comes into contact with the face over the entire surface, and thus the coating material is applied with constant layer thickness and constant depth of penetration into the through-channels on the inner surfaces of the through-channels.

In order to simplify flat application to the base and to achieve a constant settable material thickness, the coating material is formed with an increased or suitable viscosity—in particular, by the use of substances for setting the viscosity—for example, gelling agents such as polysaccharides, celluloses, and the like. The viscosity of the coating material is selected such that a uniform layer having, for example, a layer thickness of 0.2 to 4 mm can be applied to the base. The viscosity is also selected in conjunction with the surface properties of the base such that contraction or droplet formation or island formation due to the surface tension of the coating material is avoided.

Furthermore, the coating material should have shear-thinning properties, so that application of the coating material does not lead to film breaks or the like. For example, a viscosity of 0.5 to 10 Pa*s, and in particular 1 to 5 Pas, at a shear rate of 16 l/s can be suitable here (Anton Paar Rheolab QC with CC39, at 20° C., according to DIN 53019). The shear thinning (DIN 1342-3) allows the required uniform distribution of the material into a stable film.

The base is preferably elastic, with a closed surface, in order to enable an elasticity of shape when the face of the substrate is pressed on. The closed surface of the base prevents the penetration of the coating material into the material of the base and thereby ensures little loss of coating material and the longer usability of the base.

The material of the base can be an elastic plastic, a rubber, or another material. In particular, the material can be a foam rubber material with a closed surface. For example, neoprene, foam rubber, and silicone, Sylomer (“Werkstoffeigenschaften und Schwingungsisolation Technische Informationen,” RRG INDUSTRIETECHNIK GMBH, www.rrg.de), and the like can be used. The elastic property of the foam rubber material can be described, for example, with a Shore A hardness (according to DIN 53505) of between 10 and 18, and in particular 13, and/or a density of between 0.1 g/cm³ and 1 g/cm³.

In principle, the elasticity or deformability of the base can be selected such that, when the face of the substrate is pressed into the base, the unevenness of the face of the substrate results in the base lying against the entire surface of the face so that the coating material is applied to the entire face. Macroscopic unevenness of any shape of the face-side surface can be compensated for by the interaction of elasticity of the base and the force acting upon the substrate or upon the catalyst element.

The elasticity can be selected, for example, such that, with a the macroscopic unevenness of the face surface of, for example, +/−3 mm and a contact force of the substrate on the base of, for example, between 5 and 150 N, the pressed-on surface of the substrate or of the substrate is in full-surface contact in order to achieve full-surface application of the coating material on all areas of the face surface. The maximum contact force is limited by the mechanical stability of the substrate.

Thus, the material of the base can be selected with respect to its elasticity or deformability such that, in the case of a substrate with a certain unevenness of the face, said material allows the surface of the base to lie against the entire face surface.

To apply the coating material, the face of the substrate is pressed with the face onto the base, whereby the coating material is applied to the face surfaces, and wherein the flexibility of the base makes it possible to adapt to unevenness on the face of the substrate. The layer thickness of the coating material to be applied is preferably 0.2 to 4 mm, preferably 0.2 to 2 mm, and particularly preferably 0.2 to 0.6 mm. The zone length of the coating material to be applied can be determined using the viscosity of the coating material, the layer thickness applied to the base, the contact duration, and the pressing-in pressure of the substrate.

The application of a quantity of coating material to the base before the pressing-in process and the distribution on a surface in which the face surface of the substrate can be accommodated can preferably be accomplished by means of a doctor blade.

Alternatively, the coating material can also be applied to the surface of the base, prior to the pressing-in process, with the aid of a film applicator.

Furthermore, the coating material can be applied to the base, before the pressing-in process, with the aid of a slot die, the base being moved relative to the slot die. The moving base can be provided by a moving plate or a conveyor belt.

These coating forms offer the possibility of very precisely adjustable layer thickness—in particular, a constancy of less than ±0.5 mm to ±0.1 mm, and particularly preferably down to ±0.05 mm or even ±0.03 mm—and therefore—particularly in connection with the closed surface—a reproducible and defined material transfer to the carrier material.

After the face is lifted out of the coating material, the substrate can be thermally treated for drying or calcining.

According to a further aspect, a device for producing a substrate for an exhaust gas aftertreatment device is provided, comprising:
an in particular horizontally-oriented elastic base with a closed surface;
an application unit which is configured to apply a liquid coating material to the base;
a pressing-in unit which is configured to dip or press, after the application of the coating material, a substrate to be coated into the coating material.

According to a further aspect, a substrate is provided according to one of the above methods.

### SHORT DESCRIPTION OF THE DRAWINGS

Embodiments are explained in more detail below with reference to the accompanying drawings. The following are shown:

FIG. 1 a perspectival view of a face of a substrate for an exhaust gas aftertreatment device;

FIG. 2 a cross-sectional view through a substrate, to illustrate an uneven face;

FIG. 3 a device for applying a coating to a face of a substrate; and

FIG. 4 a flowchart to illustrate the method for producing a substrate with a face coating.

### DESCRIPTION OF EMBODIMENTS

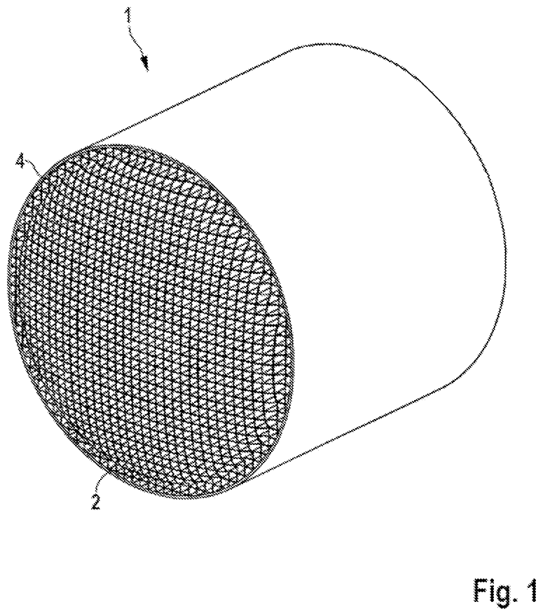

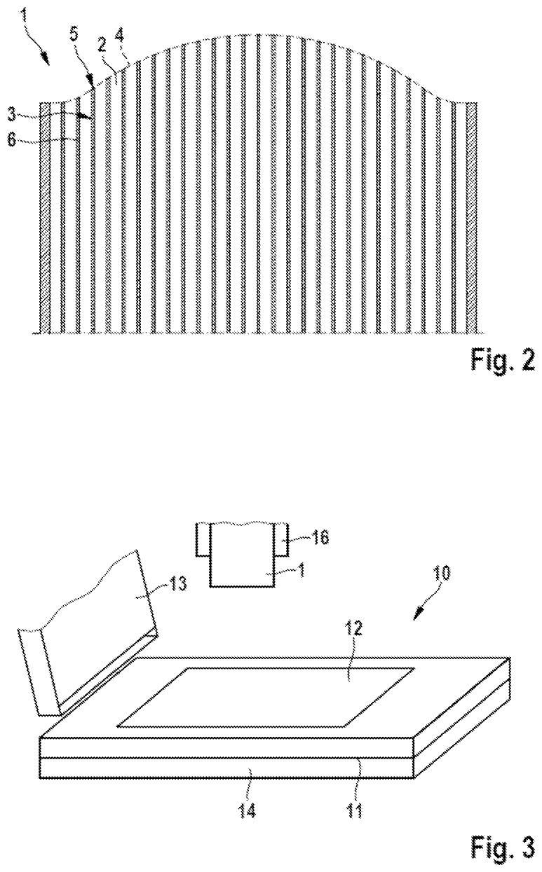

FIG. 1 shows a perspectival view of a substrate 1 as used in conventional exhaust gas aftertreatment devices—for example, as a catalyst element. FIG. 2 shows a cross-sectional view through the substrate 1.

The substrate 1 is preferably formed from a porous and in particular ceramic substrate material. The substrate 1 has through-channels 2 running parallel to one another, the inner walls 3 of which are coated with a catalyst material in a manner known per se. Such a catalyst material can have catalytically-active components such as precious metals, and in particular platinum, palladium, rhodium, or also base metals such as Cu, Fe, Mn, V, Co, Ni. The catalytically-active component can be present in dissolved form, e.g., dissolved salt, in the liquid or can be bound beforehand to a carrier oxide. A plurality of materials are known, e.g., aluminum oxide, silicon oxide, titanium oxide, cerium oxide, zirconium oxide in pure form, doped, e.g., with lanthanum, silicon, cerium, magnesium, or barium, or in combination with one another.

The through-channels 2 can have a round, hexagonal, or square cross-section, or a cross-section shaped in some other way. The through-channels 2 end at a face 4 of the substrate 1 so that the face 4 of the substrate 1 has inlet openings 5 for the through-channels 2.

As shown in the sectional view through the substrate in FIG. 2, the face, apart from the inlet openings of the through-channels (i.e., over the entire extension of the face), is not flat, but can be deformed in the axial direction and can have a concave and/or convex and/or otherwise uneven structure. The through-channels 2 are separated from one another in the substrate material of the substrate 1 by intermediate walls 6 which, at the face, lead to web-like structures between the inlet openings 5 of the through-channels 2.

In the following, a device and a method are described by means of which a coating can be applied to the face of the substrate 1, which coating serves to prevent face plugging. Suitable materials for such a coating are a precious-metal-containing solution, which can differ with respect to composition and materials from the layer material, which is applied to the inner walls of the through-channels before or after the coating of the faces.

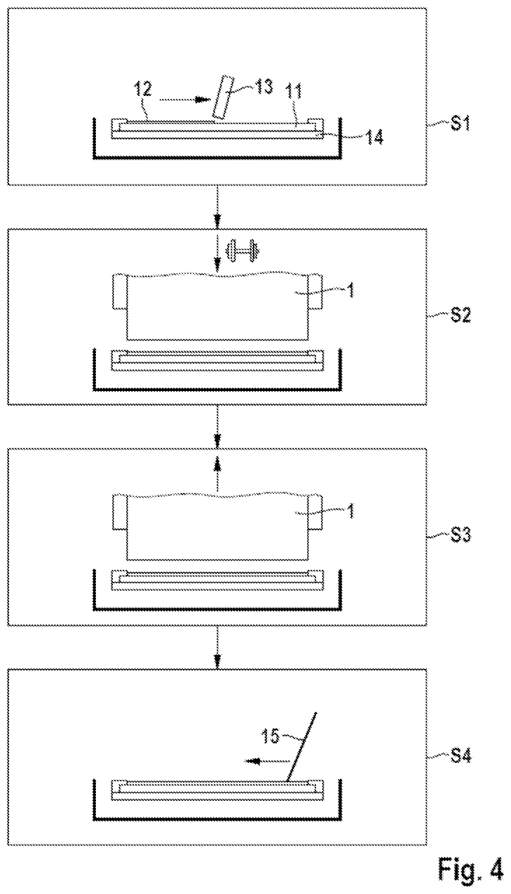

FIG. 3 shows a schematic illustration of a device 10 for applying a coating to the face of a substrate 1. In conjunction with the schematic illustrations of FIG. 4, a process sequence for the production of the substrate 1 with a coating for preventing face plugging is described.

FIG. 3 shows a device 10 with an elastic base 11 onto which a coating of a liquid coating material 12 can be applied by means of an application unit 13.

The base 11 can correspond to a foam material having a smooth and closed surface. The closed surface prevents the penetration of the coating material into the foam material, and thereby ensures less material loss. In order to guarantee the most uniform possible exertion of pressure, the base 11 is supported by a fixed, non-elastically-deformable base plate 14.

The coating material can be a material with a viscosity such that it can be applied with a layer thickness between 0.2 and 3 mm on a flat surface of the base 11 so that it forms a closed surface.

The coating material 12 can be applied by means of an application unit 13. In particular, the coating material 12 can be applied by placing the coating material on the elastic base 11 and distributing it by means of a doctor blade or an application using a film applicator (as an application unit).

Alternatively, as sketched in FIG. 3, in step S1, the coating material 12 can be applied via a slot die 13 (as an application unit), which moves in a translatory manner relative to the base 11 at a constant distance and at the same time releases the liquid coating material 12. The coating material 12 can a precious-metal-containing solution which, with the aid of a gelling agent, is increased in viscosity to such an extent that a coherent wet film of constant thickness can be applied to the base 11.

The base moved relative to the slot die can have a moving plate or a conveyor belt, so that a very precisely adjustable layer thickness, and therefore—particularly in connection with the closed surface—a reproducible and defined material transfer to the substrate.

After the application of the coating material 12, in step S2, the face of the substrate 1 to be coated is pressed into the material by means of a pressing-in unit 16—in particular, perpendicularly to the surface direction of the base 11. In the process, the base 11 deforms due to its elasticity, so that the web-shaped surfaces come into contact with the coating material 12 even in the case of an uneven face. It is thereby possible to wet a complete coating of all surface portions of the face of the substrate 1, which are formed by the web-like walls between the through-channels 2, with the coating material, in order to thereby reduce or prevent face plugging over the entire face.

After the lifting off of the substrate 1 in from the base, in step S3, the substrate 1 wetted with the coating material 12 is lifted off from the base and can then, if necessary, be fed to a separate thermal treatment to dry or calcine the applied coating material.

Subsequently, in step S4, the coating material 12 is removed from the base 11, e.g., by means of a scraper 15, and the base is thus again prepared for a subsequent coating of a substrate 1 with a constant wet film thickness.

1. Method for producing a substrate (1) for an exhaust gas aftertreatment device, having the following steps:
applying (S1) a coating material (12) on an elastic base (11);
dipping or pressing (S2) a surface of the substrate (1), in which inlet openings of through-channels (2) are arranged, through the substrate (1) into the coating material (12);
lifting off the coated catalyst element (1); and
aftertreating, and in particular drying or calcining (S3), the coating material (12) on the coated substrate (1).

2. Method according to claim 1, wherein the coating material (12) comprises a catalytically-active component, and in particular a precious-metal-containing solution.

3. Method according to claim 1, wherein the surface of the substrate (1) to be coated has a convex or concave or otherwise irregularly-shaped structure with respect to its axial direction.

4. Method according to claim 1, wherein the liquid coating material (12) is applied to the elastic base (11) in a planar manner, and in particular with a constant layer thickness.

5. Method according to claim 1, wherein the coating material (12) is provided with a viscosity—in particular, by the use of a gel former, such as polysaccharide—so that a uniform layer having, in particular, a layer thickness of 0.2 to 4 mm can be applied to the base.

6. Method according to claim 1, wherein the coating material is shear-thinning, so that the application of the coating material does not lead to film breaks, wherein a viscosity of the coating material at 20° C. of 0.5 to 10 Pa*s, and in particular of 1 to 5 Pa*s, at a shear rate (DIN 53019) between 12 and 20 l/s, and in particular between 14 and 17 l/s, is selected.

7. Method according to claim 1, wherein the base (11) has an elastic plastic or a rubber material, and in particular a foam rubber material, and has a smooth and/or closed surface.

8. Method according to claim 1, wherein the coating material (12) is applied to the base (11) by a doctor blade or by a film applicator on the base or by a slot die (13) on the base (11), which is moved relative to the slot die.

9. Method according to claim 1, wherein the residual coating material (12) of a preceding coating operation remaining before the application of the coating material (12) is removed in particular by scraping.

10. Device (10) for manufacturing a substrate (1) for an exhaust aftertreatment device, comprising:
an in particular horizontally-oriented elastic base (11) with a closed surface;
an application unit (13) which is configured to apply a liquid coating material (12) to the base (11);
a pressing-in unit (16) which is configured to dip or press, after the application of the coating material (12), a substrate (1) to be coated into the coating material (12).

11. Device according to claim 9, wherein a non-elastically-deformable base plate (14) is arranged below the elastic base (11).

12. Substrate (1) produced according to the method according to claim 1.
